(19) United States
(12) Patent Application Publication
(10) Pub. No.: US 2009/0312082 A1
(43) Pub. Date: Dec. 17, 2009

(54) BINGO GAME APPARATUS WITH VARIABLE PAYOUT CAPABILITY

(75) Inventor: Shun-Tsung HSU, Taichung (TW)

Correspondence Address: PATENTTM.US, P. O. BOX 82788, PORTLAND, OR, 97282-0788, US

(73) Assignee: Tien-Shu HSU, TAICHUNG (TW)

(21) Appl. No.: 12/137,068

(22) Filed: Jun. 11, 2008

(51) Int. Cl. A63F 3/06; A63F 13/12

(52) U.S. Cl. 463/19; 463/22; 463/26; 463/27

(57) ABSTRACT

A Bingo game apparatus with variable payout capability has a server apparatus, a random number generator and multiple player terminals. The server apparatus runs a Bingo game program with variable payout capability. The Bingo game program with variable payout capability comprises acts of: setting up and buying Bingo cards, accumulating prizes, judging preset Jackpot prize, drawing balls, paying out the Jackpot prize and generating new Jackpot prize target, judging BINGO occurrence, paying out BINGO prize, judging special BINGO occurrence and paying out the special BINGO prize and generating a new special BINGO prize. Flexibility of payout rules of the Bingo game apparatus is increased since players may define preferred pay rule settings and credit value before play and have chances to win a normal Jackpot prize, the special BINGO prize or both.

### BACKGROUND OF THE INVENTION

1. Field of Invention

The present invention relates to a Bingo game apparatus, and more particularly to a Bingo game apparatus with variable payout capability.

2. Description of the Related Art

Conventional electronic Bingo gaming apparatus are well known and are popular in Casinos. Bingo is a game of chance in which randomly selected numbers are drawn and players match those numbers to numbers appearing on cards (Bingo cards). Each card contains a grid of rows and columns of numbers (3×3, 4×4, 5×5, 3×15 and the like), which are printed or electronically presented. Players purchase the cards to join in the game. Take the 5×5 card as an example, columns of each Bingo card are respectively identified by letters B, I, N, G and O. Numbers are provided or printed in coordinates (positions of the matrix of each Bingo card) in the matrix of each Bingo card. Often, the center coordinate in the matrix leaves blank or is marked “Free” rather than having an assigned number. After each player has purchased a card, means are provided to randomly select numbers identified by the column letter and a number. For instance, O62 is denoted for a number “62” on column “O”. The printed numbers on the card correspond to the following arrangement: 1 to 15 in the B column; 16 to 30 in the I column; 31 to 45 in the N column; 46 to 60 in the G column and 61 to 75 in the O column. Typically, one number is provided by drawing a ball from a cage, a mixer or an electrical drawing machine, wherein multiple balls are contained inside the cage or the mixer and each ball is printed an independent number thereon.

The selection of balls continues until one player has a card marked (corresponding numbers have been drawn) in a winning pattern. This winning pattern might be designated before the game, such like a row, a column, two columns, four corners, an X-pattern, a cover all (all numbers on the Bingo card are covered) or the like. However, to play the game a number of players are required to provide a number of Bingo cards with different numbers so that a single or few winners can be declared. Hence, the requirement of having a number of players perhaps hundreds of players is necessary for conventional Bingo game that is inflexible.

Especially, payout rules of conventional Bingo game are also limited since prizes of the game are based on the number of players. In general, a total prize of the Bingo game corresponds to a ratio of a total income from sold Bingo cards. The ratio may be defined before the game start. For instance, the total prize Bingo game is 50% of the total income when the ratio is defined as 50%. When the total income is few caused by a small number of players, the total prize of the game is limited and discourages players to participate in the game.

Furthermore, players participate in the game under fixed pay rules and only have chances to win a fixed payout when one of the Bingo cards is Bingo. Two players have to share the prize when they have Bingo at the same time. Furthermore, the conventional Bingo game discourages the players to participate since players can not win an extra bonus or prizes with buying more Bingo cards that are not Bingo, and players can not choose specific pay outs before participating in a game.

The present invention provides a Bingo game apparatus with variable payout capability and method of implementing the same to obviate or mitigate the shortcomings of the conventional electronic Bingo game apparatus.

### SUMMARY OF THE INVENTION

The primary objective of the present invention is to provide a Bingo game apparatus with variable payout capability to resolve unexciting problems of pay out rules for conventional Bingo gaming apparatus.

The Bingo game apparatus with variable payout capability has a server apparatus, a random number generator and multiple player terminals. The server apparatus runs a Bingo game program with variable payout capability. The Bingo game program with variable payout capability comprises acts of: setting up and buying Bingo cards, accumulating prizes, judging preset Jackpot prize, drawing balls, paying out the Jackpot prize and generating new Jackpot prize target, judging BINGO occurrence, paying out BINGO prize, judging special BINGO occurrence and paying out the special BINGO prize and generating a new special BINGO prize. Flexibility and variety of payout rules of the Bingo game apparatus is increased since players are capable of defining preferred pay rule settings and credit value before play and have chances to win a normal Jackpot prize, the special BINGO prize or both.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a Bingo game apparatus with variable payout capability in accordance with the present invention;

FIG. 2 is a flow chart of a Bingo game program with variable payout capability in accordance with the present invention;

FIG. 3 is a status of the Bingo game program with variable payout capability in accordance with the present invention; and

FIG. 4 is a block diagram of another embodiment of the Bingo game apparatus with variable payout capability in accordance with the present invention.

### DETAILED DESCRIPTION OF THE INVENTION

As defined herein, specific integers refer to numbers, letters, pictures or specific decimals, characters, fractions or the like that may be used to label and indicate which of a selected list has been chosen and can be marked easily on a corresponding table. Normally full numbers running upwards from one (1) are implemented.

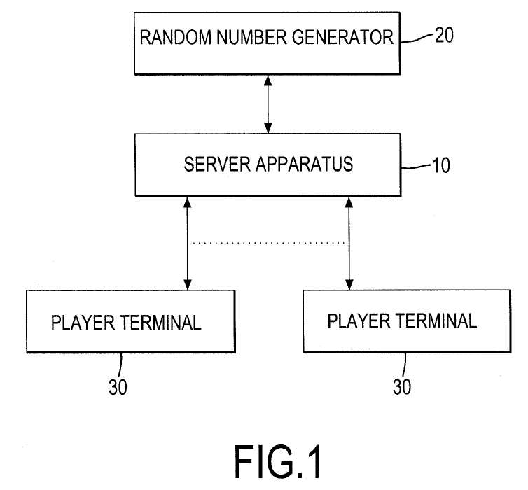

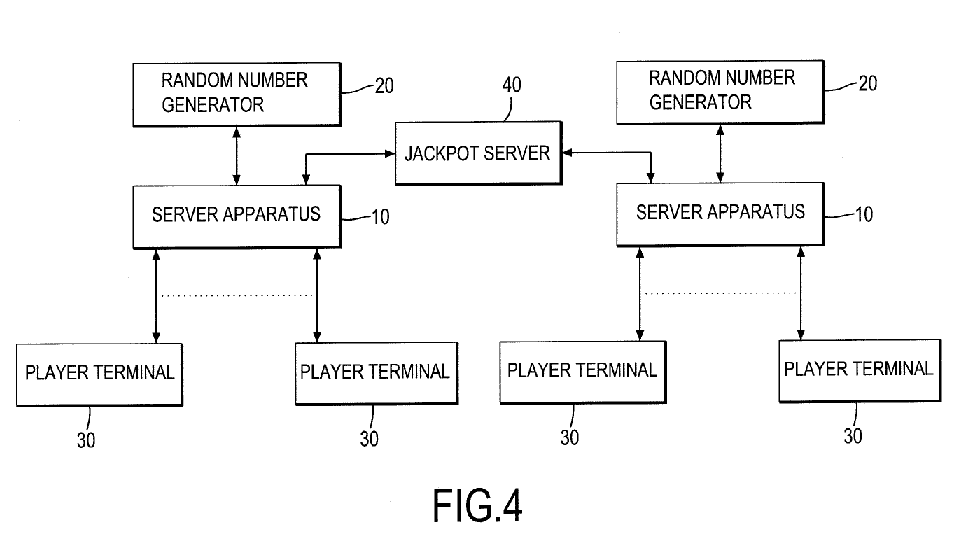

With reference to FIGS. 1 and 4, a Bingo game apparatus with variable payout capability in accordance with the present invention comprises at least one apparatus group and an optional Jackpot server (40).

Each apparatus group comprises a server apparatus (10), a random number generator (RNG) (20) and multiple player terminals (30). Each apparatus group is placed at different locations, such like different states, cities, branch stores, floors or the like for players at different locations can conveniently participate in.

The server apparatus (10) runs a Bingo game program with variable payout capability and may have a display displaying statuses of the Bingo game program with variable payout capability.

The RNG (20) is electronically connected to the server apparatus (10), is controlled by the server apparatus (10) to successively generate randomly one of a range of integers and may be a ball drawing machine or the like. The ball drawing machine contains multiple balls each having one of a set range of integers printed thereon and is controlled by the server apparatus (10) to successively draw one of the balls. The set range of integers may be 1˜75.

Each player terminal (30) is electronically connected to the server apparatus (10), corresponds to a player participating in the Bingo game program with variable payout capability and may have an Input/Output (I/O) interface for the player to change the status of the Bingo game program with variable payout capability, such like loading money, placing wagers, buying Bingo cards or the like

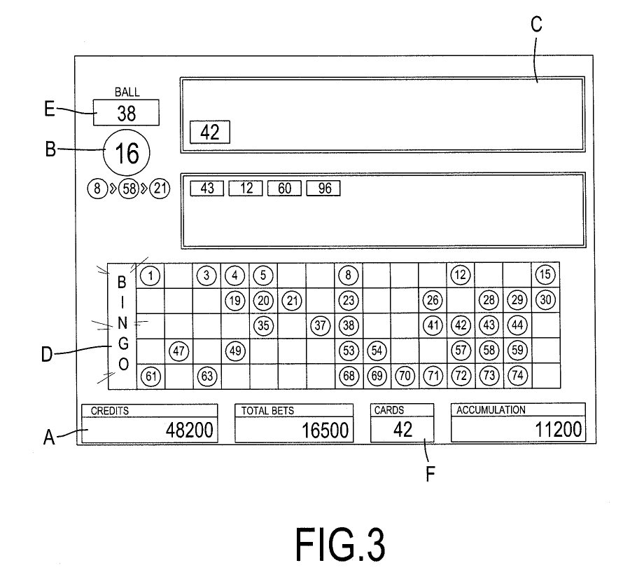

FIG. 3 shows an example of the status of the Bingo game program with variable payout capability shown on the I/O interface to the player, where the status may contain information such as loaded money (A), last drawn ball (B), Bingo card having highest possibility of achieving BINGO (C), drawn balls (D), total numbers of drawn balls (E), numbers of bought Bingo cards by player (F) and the like.

The Jackpot server (40) may be electronically connected to each server apparatus (10) and receives wagers loaded by the players from each server apparatus (10) of each corresponding apparatus group and accumulates a wager.

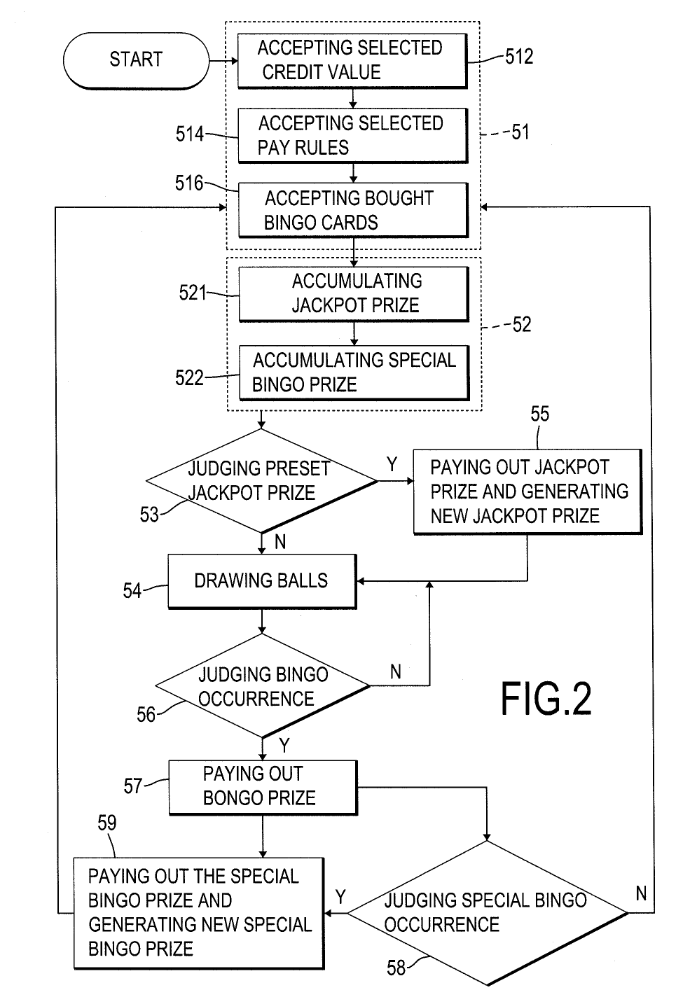

With reference to FIG. 2, the Bingo game program with variable payout capability comprises acts of: setting up and buying Bingo cards (51), accumulating prizes (52), judging preset Jackpot prize (53), paying Jackpot prize and generating new Jackpot prize target (55), drawing balls (54), judging BINGO occurrence (56), paying out BINGO prize (57), judging special BINGO occurrence (58) and paying out the special BINGO prize and generating a new special BINGO prize (59).

In the act of setting up and buying Bingo cards (51), each player terminal (30) may be operated by a player to accept a preferred credit value item from a credit value table, a preferred pay rule setting from a multiple pay rules table and buying preferred Bingo cards selected by a corresponding player. Wherein, the credit value table is created and is shown on the player terminal (30) and comprises multiple credit value items. Each credit value item defines a ratio of money being loaded into the player terminal (30) to credit points for the Bingo game program with variable payout capability. For instance, the credit value table may comprise four credit value items respectively are 1 dollar, 50 cents, 25 cents and 10 cents. A player selecting a “50 cents” credit value item would receive two credit points for every dollar loaded. The multiple pay rules table is created and is shown on the player terminal (30) and comprises multiple pay rules settings. Each pay rules setting defines relations between counts of drawn integers (balls) being “Bingo” with the pay rules. Wherein, the multiple pay rules table may be created by the server apparatus (10) or the player terminal (30). An example of one of the pay rule settings of the multiple pay rules table may be defined in Table 1.

TABLE 1

| Ball number | Pay rule Setting |
|---|---|
| 46 | 5000 |
| 48 | 2000 |
| 50 | 1000 |
| 52 | 800 |
| 54 | 400 |
| 56 | 130 |
| 58 | 105 |
| Over 58 | 85 |

With reference to the Table 1, when a Bingo card has a BINGO on the forty-sixth drawn ball, for example, players who bought the Bingo card win their corresponding placed bets times 5000.

The setting and buying Bingo cards (51) may comprise acts of: accepting selected credit value (512), accepting selected pay rules (514) and accepting bought Bingo cards (516).

In the act of accepting selected credit value (512), the player terminal (30) accepts input from a corresponding player to select the preferred credit value item from the shown credit value table.

In the act of accepting selected pay rules (514), the player terminal (30) accepts input from the corresponding player to select a preferred pay rules setting from the shown multiple pay rules table.

In the act of accepting bought Bingo cards (516), the server apparatus (10) generates a set of Bingo cards, sending the set of Bingo cards to the player terminals (30) and each player terminal (30) accepts an input from the corresponding player to select at least one preferred Bingo card. Each Bingo card is independent, may comprise a grid containing multiple integers selected from the integers (e.g. 1˜75). Players place wagers to buy and bet on preferred Bingo cards by using the player terminals (30). Wherein, the players may place wagers to buy the preferred Bingo card in period of a betting time. For instance, when the player terminal (30) shows the set of Bingo cards (e.g. shown 100 independent Bingo cards at a gaming round, the Bingo cards may be numbered as 00, 01 . . . 99) to the corresponding player, the betting time starts to count down. The player may use the player terminal (30) to buy the preferred Bingo card from the set of the Bingo cards until the betting time is expired.

The act of accumulating prizes (52) comprises acts of accumulating Jackpot prize (521) and accumulating special Bingo prize (522).

In the act of accumulating Jackpot prize (521), a ratio of placed wagers for buying Bingo cards is accumulated by the server apparatus (10) or the Jackpot server (40) as a current Jackpot prize. For example, if the ratio is defined to be 5%, means five percent of the placed wagers from each player buying Bingo cards will be added into the current Jackpot prize by the server apparatus (10) or the Jackpot server (40).

In the act of accumulating special Bingo prize (522), a ratio of the placed wagers from each player buying Bingo cards is accumulated by the server apparatus (10) or the Jackpot server (40) as a current special Bingo prize.

In the act of judging preset Jackpot prize target (53), the server apparatus (10) or the Jackpot server (40) judges whether the current Jackpot prize is greater than a Jackpot prize target being randomly generated by the server apparatus (10) or the Jackpot server (40). If the current Jackpot prize is beyond the preset Jackpot prize target, the act of paying out the Jackpot prize and generating new Jackpot prize target (55) is performed, else the drawing balls (54) is performed.

In the act of the paying out the Jackpot prize and generating a new Jackpot prize target (55), the server apparatus (10) or the Jackpot server (40) pays the preset Jackpot prize to the player who placed the wager that made the current Jackpot prize at least equal to the preset Jackpot prize target and randomly generates a new Jackpot prize target.

In the act of drawing balls (54), the server apparatus (10) controls the RNG (20) to randomly generate integers one by one.

In the act of judging BINGO occurrence (56), the server apparatus (10) checks “BINGO” occurrences of the Bingo cards after each integer has been drawn. If BINGO has occurred on a Bingo card, the act of the paying out the Bingo prize is performed, else the act of drawing balls (54) is repeated.

In the act of the paying out the Bingo prize (57), the server apparatus (10) pays out a normal Bingo prize for at least one player terminal (30) corresponding to a winning Bingo card attaining a BINGO. The normal Bingo prize is a preset prize corresponding to the selected pay rule setting and placed wagers by the player on the act of setting and buying Bingo cards (51).

In the act of judging special BINGO occurrence (58), the server apparatus (10) compares a special drawn-ball count and count of drawn integers. The special drawn-ball count is generated at a beginning of the Bingo game program with variable payout capability is performed. When the count of drawn balls at a BINGO equals the special drawn-ball count, the act of paying out the special Bingo prize and generating new special Bingo prize (59) is performed, otherwise the act of setting and buying Bingo cards (51) is performed to start a new round.

In the act of paying out the special Bingo prize and generating new special Bingo prizes (59), the server apparatus (10) pays out a portion of the current special Bingo prize to the winning Bingo cards according to a special Bingo payout rule. The special Bingo payout rule uses at least one predetermined special Bingo number and the total number of drawn-balls when Bingo is claimed. Each special Bingo number may be pre-weighted. The special Bingo number and weighting may be selected at random, preprogrammed or calculated. Each player holding Bingo cards that win when the total number of drawn balls equals this number. After the current special Bingo prize is completely paid, the server apparatus (10) generates a new initial special Bingo prize to prevent zero payouts occurring. When multiple Bingo cards win and the special Bingo prize is paid, each card is allocated an equal share. For instance, the server apparatus (10) defines the special drawn-ball count being 48 balls and 50 balls and the special Bingo payout rule may be defined as follows: When the total drawn balls numbers are 48 balls, 49 balls or 50 balls, 50%, 25% or 20% of the current special Bingo prize is respectively given as prize money.

When more than one special Bingo number is selected, a lower number may win stakes for that number and higher numbers. Therefore, in the above example, at 50 balls, 20% of the special Bingo prize is given, at 49 balls, 45% of the special Bingo prize is given and at 48 balls, 95% of the special Bingo prize is given. Should 5 cards win the special bingo prize at the time, each card would be respectfully given 4%, 9% and 19% of the special Bingo prize.

Numbers not specified as special Bingo numbers may or may not allow a win. In the former case, a Bingo at 47 drawn balls would also give 95% of the special Bingo prize. However, in the latter case, a Bingo at 47 drawn balls would not give any special Bingo prize.

As described above, the Bingo game apparatus with variable payout capability in accordance with the present invention provides different payout capability for the players including multiple pay rules, Jackpot prize and the special Bingo prize. Hence, the players will be encouraged to buy more Bingo cards since they have chances to win on different payout rules. Furthermore, the invention provides players at different location having chances to win the same Jackpot prize since the Jackpot server (40) coordinates the accumulation of the Jackpot prize from the placed wagers by the players.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A Bingo game apparatus with variable payout capability comprising at least one apparatus group, each one of the at least one apparatus group comprising
a server apparatus running a Bingo game program with variable payout capability, displaying statuses of the Bingo game program with variable payout capability;
a random number generator (RNG) being electronically connected to the server apparatus and being controlled by the server apparatus to successively generate randomly one of a range of integers; and
multiple player terminals, each player terminal being electronically connected to the server apparatus, corresponding to a player for participating in the Bingo game program with variable payout capability, displaying the statuses and accepting inputs to change the statuses of the Bingo game program with variable payout capability;
wherein, the Bingo game program comprises acts of
setting up and buying Bingo cards, each player terminal accepting a preferred credit value item, a pay rule setting and buying preferred Bingo cards selected from a corresponding player terminal;
accumulating prizes, a ratio of placed wagers being accumulated into a current special Bingo prize;
drawing balls, the server apparatus controlling the RNG to generate one integer;
judging BINGO occurrence, the server apparatus checking BINGO occurrence of the Bingo cards after each integer having been drawn;
paying out BINGO prize, the server apparatus paying out a normal Bingo prize to at least one player terminal corresponding to a winning Bingo card attaining a BINGO, the normal Bingo prize being a prize corresponding to the selected pay rule setting and placed wagers; and
judging special BINGO occurrence, the server apparatus comparing a special drawn-ball count and a count of drawn integers required to achieve BINGO, wherein acts of paying out special Bingo prize and generating new special Bingo prize is performed when the count of drawn integers equals the special drawn-ball count.

2. The Bingo game apparatus with variable payout capability as claimed in claim 1, wherein the Bingo game apparatus comprises
multiple apparatus groups; and
a Jackpot server being electronically connected the server apparatus of each apparatus group wherein
in the act of accumulating Jackpot prize, the wagers are accumulated by the Jackpot server; and
in the act of judging present Jackpot prize target, the Jackpot server judges whether the current Jackpot prize is greater than a jackpot prize target being randomly generated by the Jackpot server.

3. The Bingo game apparatus with variable payout capability as claimed in claim 1, wherein the RNG is a ball drawing machine, the ball drawing machine contains multiple balls each having one of a set range of integers printed thereon and being controlled by the server apparatus to successively draw one of the balls.

4. The Bingo game apparatus with variable payout capability as claimed in claim 2, wherein the RNG is a ball drawing machine, the ball drawing machine contains multiple balls each having one of a set range of integers printed thereon and being controlled by the server apparatus to successively draw one of the balls.

5. A Bingo program with variable payout capability for a server apparatus being connected to multiple player terminals and a random number generator, the random number generator successively generating randomly one of a range of integers and the bingo program comprising acts of
setting up and buying Bingo cards comprising each player terminal accepting a preferred credit value item, a pay rule setting and buying preferred Bingo cards selected by a corresponding player;
accumulating prizes comprising acts of
accumulating a Jackpot prize being a ratio of wagers being accumulated into a current Jackpot prize; and
accumulating a special Bingo prize being a ratio of the wagers being accumulated into a current special Bingo prize;
judging preset Jackpot prize comprising judging if the current Jackpot prize has been accumulated beyond a preset Jackpot prize target being randomly generated;
paying out the Jackpot prize and generating a new Jackpot prize target comprising judging when the current Jackpot prize is at least equal to the preset Jackpot prize and the player terminal placing the wager to make the current Jackpot prize at least equal to the preset Jackpot prize target being paid the current Jackpot prize and a new Jackpot prize target being generated;
drawing balls comprising the server apparatus controlling the RNG to generate one integer;
judging BINGO occurrence comprising the server apparatus checking BINGO occurrence of the Bingo cards after each integer having been drawn;
paying out BINGO prize comprising the server apparatus paying out a normal Bingo prize to at least one player terminal corresponding to a winning Bingo card attaining a BINGO, the normal Bingo prize being a prize corresponding to the selected pay rule setting and placed wagers;
judging special BINGO occurrence comprising comparing a special drawn-ball count and a count of drawn integers required to achieve BINGO; and
paying out the special BINGO prize and generating new special BINGO prize comprising the server apparatus paying out a portion of the current special Bingo prize to each player terminal corresponding to the winning Bingo cards according to a special Bingo payout rule and generating a new prize when the current special bingo prize is zero.

6. The Bingo program with variable payout capability as claimed in claim 5, wherein setting up and buying Bingo cards comprises acts of
accepting selected credit value comprising the player terminal accepting input to select a preferred credit value item from a credit value table;
accepting selected pay rules comprising the player terminal accepting input to select a preferred pay rules setting from a multiple pay rules table; and
accepting bought Bingo cards comprising the server apparatus generating a set of Bingo cards, sending the set of Bingo cards to the player terminals and each player terminal accepting input to select at least one preferred Bingo card.
